(19) United States
(12) Patent Application Publication
(10) Pub. No.: US 2006/0190981 A1
(43) Pub. Date: Aug. 24, 2006

(54) Carousel technology for interactive television

(75) Inventors: Laurant Weill, Svres Cedex (FR); Pascal-Hippolyte Besson, Soindres (FR)

Correspondence Address: FOLEY & LARDNER, 2029 CENTURY PARK EAST, SUITE 3500, LOS ANGELES, CA, 90067, US

(73) Assignee: Visiware

(21) Appl. No.: 11/245,940

(22) Filed: Oct. 7, 2005

Related U.S. Application Data
(60) Provisional application No. 60/616,896, filed on Oct. 7, 2004.

(51) Int. Cl. G06F 13/00; H04N 7/16; H04N 7/173; G06F 3/00; H04N 5/445

(52) U.S. Cl. 725/135; 725/109; 725/110; 725/37

(57) ABSTRACT

A broadcast data stream is received on a device with a receiver and a processor. The system allows to broadcast multiple ITV applications (such as games). This system serially organizes the data on the broadcast stream which hosts several applications but are available in order, one at a time. The system provides a way to know when each application in the stream will be available for the user.

### CROSS-REFERENCE TO RELATED PATENT APPLICATIONS

This application is a An application claiming the benefit under 35 USC 119(e) U.S. Application 60/616,896, filed Oct. 7, 2004, incorporated herein by reference in its entirety.

### FIELD OF THE INVENTION

The present invention relates to digital broadcasting, and more specifically, to systems and methods for broadcasting and/or receiving a plurality of interactive applications on a single data channel or track. Further embodiments may employ plural tracks, each having plural applications for increasing the amount of data that may be communicated with available bandwidth.

### RELATED ART

Digital television broadcasting, also known as Interactive Television (iTV), is becoming increasing popular. iTV enables users to access interactive applications, such as email, music, video games and the like using conventional television units. As shown in FIG. 1, this type of broadcasting system typically utilizes a set-top-box (STB) device 14, which enables a conventional television set 12 to become a user interface to a communication network (such as cable, dsl, or satellite feed), also enables the television set 12 to receive and decode digital television broadcast and can offer many ITV portals. STBs are sometimes called receivers or devices. A STB may be used by television viewers who wish to employ their existing analog television sets to receive digital broadcasts.

FIG. 2 shows a conventional signal architecture for an iTV broadcast, such as DVB and OpenTV's middleware. According to this architecture, a communication broadcast sent by a broadcasting entity and received by a STB is composed of a plurality of individual signals communicated simultaneously on a corresponding plurality of transmission channels or tracks. The signals on the respective channels or tracks are represented in the drawing as PIDs 22, 24, 26 and 28 and may correspond to a plurality of interactive applications, for example video games represented as Game A, Game B, Game C and Game D. For example, Game A is broadcasted on PID1 22, Game B is broadcasted on PID2 24, Game C is broadcasted in PID3 26, and Game D is broadcasted in PID4 28, all simultaneously. Therefore, a video game may be engaged at any time by switching to the PID associated with that game.

While the bandwidth requirements of iTV applications can vary greatly, some iTV applications utilize about 200 to 300 Kb/s of bandwidth. Using those values in the example of FIG. 2, a games portal would require roughly 800 to 1200 Kb/s of bandwidth to operate the four applications. If more applications were desired to be used, a greater bandwidth capability would be needed. While the applications (such as games) used in some contexts may have such bandwidth capabilities, aspects of the present invention described below may be applicable with systems having limited bandwidth capabilities or having a need to increase the number of applications broadcasted without increasing the bandwidth. For example, modern network communication devices, including telephones, mobile phones, personal digital assistances (PDAs), and the like are provided with audio and video playing capabilities that allow users to receive broadcast signals and operate in a user-interactive manner with such signals. However, the bandwidth capabilities of such communication devices may be limited relative to conventional STB systems. Also, as interactive applications become more complex and as a greater number of such applications become available, even the bandwidth capabilities of conventional STB systems may limit the ability of a user to access certain applications. Thus, there is a need for a device and method of allowing multiple interactive applications to be accessed via digital television broadcasting, without the need to use large bandwidths.

### SUMMARY OF THE INVENTION

The present invention is directed to systems and methods for broadcasting and receiving a plurality of interactive applications on a single PID (channel or track), and thereby, enabling an increased number of applications to be provided to the user without the need to increase the operational bandwidth of the system.

The broadcast signal comprises a series of content items communicated (in a serial manner) on a single communication channel or track. Because a single channel is employed, the bandwidth requirements for the single channel signal can be much smaller than the bandwidth requirements of a multi-channel signal carrying the same type of content items.

The series of content items may be communicated in the broadcast stream in series, where the series repeats itself to provide a carouselling broadcast stream. The content items within each series may be duplicated, such that two versions of each content item appears in each series of the carouselling broadcast stream, to minimize reading errors.

Since the user can only access one application at a time, preferred embodiments provide the user with an index to inform the user about what specific application is available to the user at a given time. For example, when a user initially accesses the broadcast stream, the user may not be aware of which application is available at that time. Thus, an index may be provided, whereby the user can ascertain the accessibility of a plurality of applications (and preferably each of the application) in the broadcast stream at any given time.

### BRIEF DESCRIPTION OF THE DRAWINGS

Referring now to the drawings in which like reference numbers represent corresponding parts throughout:

FIG. 1 is a generalized representation of a conventional digital television broadcasting system.

FIG. 2 is a schematic drawing, representing a conventional broadcast signal architecture for the system (for example, based on Opentv's middleware and DVB) of FIG. 1.

FIG. 3 is a schematic drawing, representing a broadcast signal architecture for digital broadcasting and receiving systems and processes according to an embodiment of the present invention.

FIG. 4 is a diagram representing an example of an Electronic Application Guide of the digital broadcasting system of FIG. 3.

FIG. 5 is a schematic drawing, representing a more detailed description of a broadcast signal architecture of FIG. 3.

FIG. 6 is a schematic drawing, representing a broadcast signal architecture according to a further embodiment of the present invention.

FIG. 7 is a schematic drawing, representing an example of operation of a games portal with a broadcast signal architecture of an embodiment of the present invention.

FIG. 8 is a schematic drawing, representing a further example of operation of a games portal to provide the user with a loading bar display according to an embodiment of the present invention.

FIG. 9 is a schematic drawing, representing a display of a user interface for a digital broadcasting system according to an embodiment of the present invention.

FIG. 10 is a schematic drawing, representing another display of a user interface for a digital broadcasting system according to a further embodiment of the present invention.

### DETAILED DESCRIPTION OF THE PREFERRED EMBODIMENTS

The present invention is directed to systems and methods for broadcasting and receiving a plurality of interactive applications on a single PID (channel or track), and thereby, enabling an increased number of applications to be provided to the user without the need to increase the operational bandwidth of the system.

Embodiments of the present invention involve a user STB for allowing a user to receive communication signals broadcast from a broadcast transmission entity. Preferred embodiments involve a system of a plurality of user STBs, each capable of receiving communication signals from the broadcast transmission entity.

Each STB according to embodiments of the present invention employs suitable receiver and processing electronics, electronic memory and user-interface electronics to provide certain functions as described herein. The processing electronics may include or operate with software, firmware, hardware logic or combinations thereof that control the processing electronics to perform functions as described herein. The user interface electronics may include or operate with suitable user interface devices, including, but not limited to, remote controls, buttons, knobs, joy-sticks other manual operators, mouse or other cursor controllers, touch pads or touch-responsive screens, light pens or other optical input devices, or the like. Such receiver, processing, memory and user-interface electronics may be included in a STB device connected to a television set (similar to the arrangement shown in FIG. 1), directly within a television set device, or in another electronic communication device capable of receiving a broadcast signal, including, but not limited to, a telephone, mobile phone, personal computer, other network computer, or the like.

The STB receiver and processing electronics described above are configured to receive signals communicated from the transmission entity. The transmission entity includes a transmission system (not shown) for broadcasting at least one broadcast signal having a signal architecture in accordance with embodiments of the present invention.

An example of a broadcast signal transmitted by the transmission system and received by the STB according to a generalized embodiment of the present invention is shown in FIG. 3. The broadcast signal shown in FIG. 3 comprises a series of content items 34, 36, 38 and 40 communicated (in a serial manner) on a single communication channel or track, identified as PID1 32. Because a single channel is employed in FIG. 3, the bandwidth requirements for the single channel signal can be much smaller than the bandwidth requirements of a multi-channel signal carrying the same type of content items as shown in FIG. 2.

As a representative example, the series of plural different content items 34, 36, 38 and 40 may comprise the content for four different video games. However, other embodiments may employ other types of content items, including, but not limited to, movies, video clips, audio clips, other software applications or programs, or the like. For purposes of simplifying the present disclosure, embodiments of the present invention are described herein with reference to four different content items in the form of four video games (Game A, Game B, Game C and Game D). It will be understood, however, that further embodiments of the invention are not limited to systems or processes that communicate video games and may be employed for broadcast communication of other types of content items, such as described above. Also, it will be understood that other embodiments may be employed for communication 2, 3 or a greater number than 4 different content, items.

While multiple different applications (Game A, Game B, Game C and Game D) are shown in the multiple-channel signal architecture of FIG. 2, those same applications (games) are transmitted and received in a single channel or track (PID2 32) of limited bandwidth according to the signal architecture of FIG. 3. However, in the embodiment shown in FIG. 3, the applications (games) can only be accessed by a user, one at a time. To allow continued access to all of the applications, the broadcast signal comprises the applications (games) in a carousel fashion, represented by the carouselling broadcast stream 50. Therefore, a given application (e.g., Game A) will become available to the user for an intermittent time before the next application (e.g. Game B) becomes available to the user and this process continues until all of the applications has been made available, one at a time. Thereafter, the same order of applications is repeated in the broadcast stream.

Since the user can only access one application at a time, preferred embodiments provide the user with an index to inform the user about what specific application is available to the user at a given time. For example, when a user initially accesses the broadcast stream 50, the user may not be aware of which application is available at that time (e.g., Game C may be available). Thus, an index may be provided, whereby the user can ascertain the accessibility of a plurality of applications (and preferably each of the application) in the broadcast stream 50 at any given time.

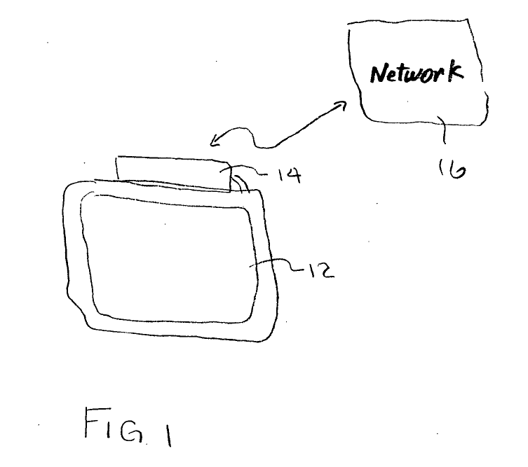

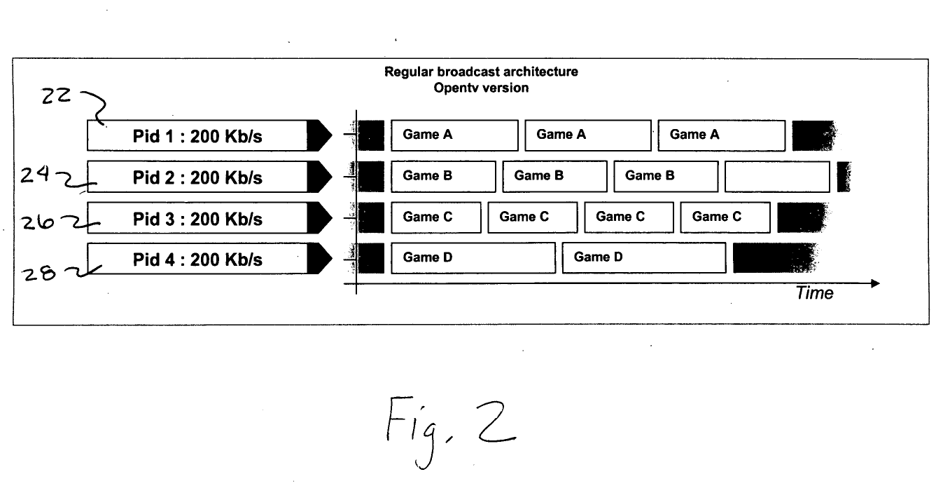

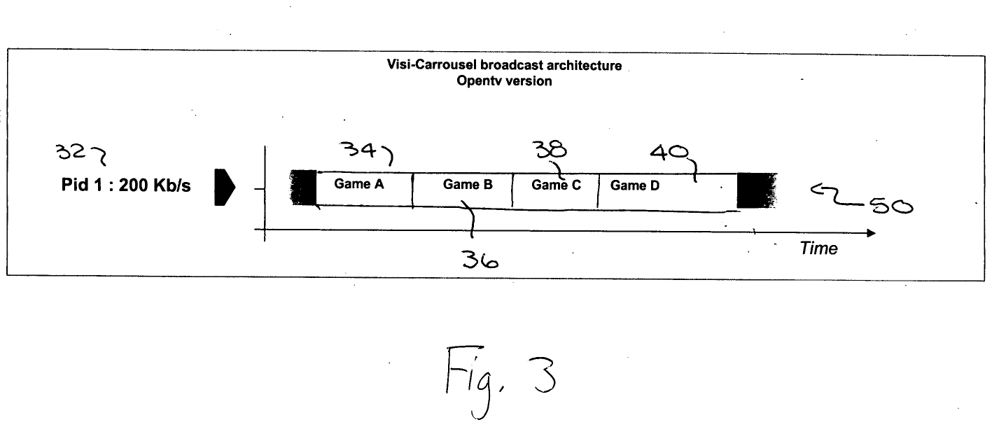

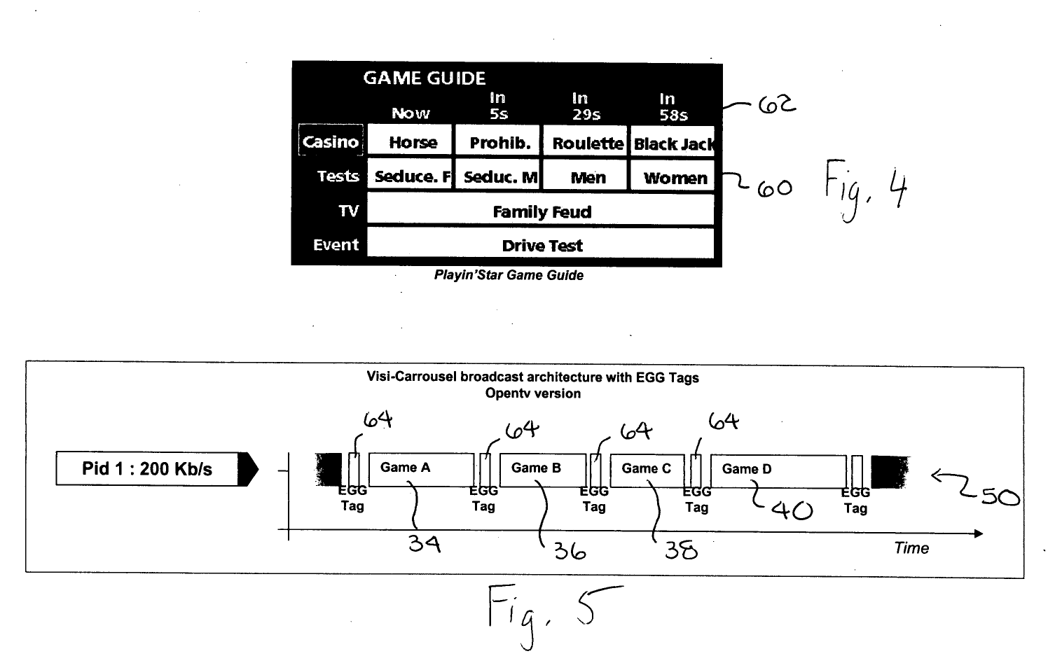

A representative example of an index is shown in FIG. 4, as a real-time Electronic Game Guide (EGG) 60. The EGG comprises a plurality of pallets 62 containing information regarding the availability of each application in the broadcast stream 50, as will be discussed in detail below. The EGG may be displayed on a display device associated with the user's STB, such as, but not limited to, a television display. A further description of the EGG 60 embodiment shown in FIG. 4 is provided further below.

As shown in FIG. 5, the EGG is generated from data files called EGG tags 64 disposed in the carouselling broadcast stream 50 by the transmitting entity. The EGG tags 64 contain information (e.g., some or all of a name, data size and code size) regarding a plurality (preferably all) of the applications in the carouselling broadcast stream 50. Each EGG tags may also contain a unique ID to allow the receiver system to determine what applications are in the carouselling broadcast stream 50 at or near the time at which the particular EGG tag occurs in the stream 50.

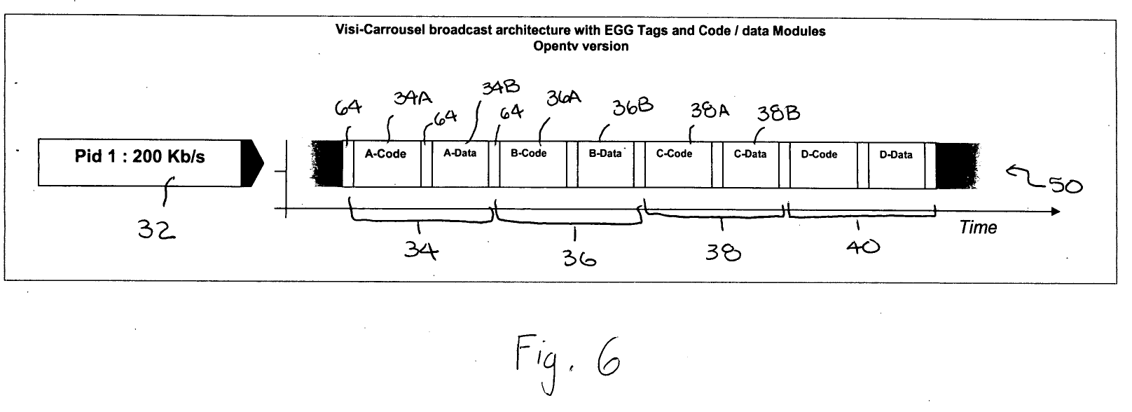

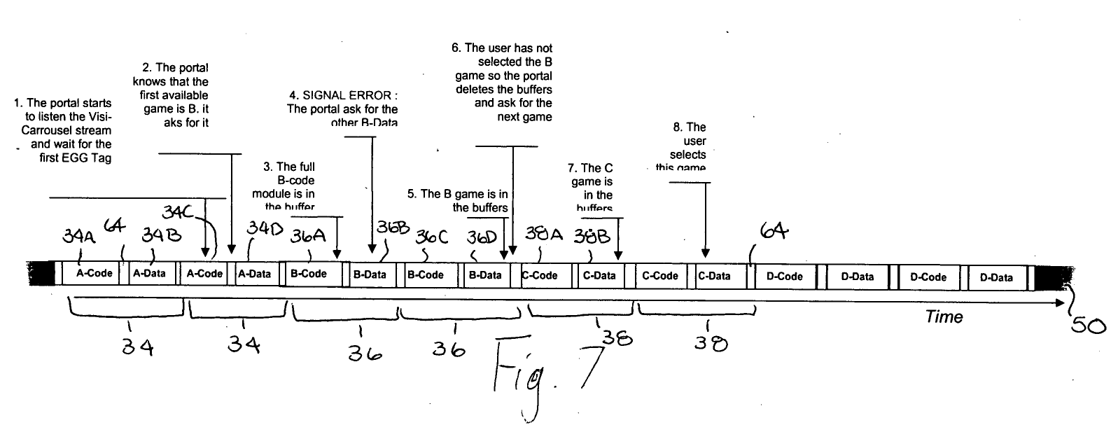

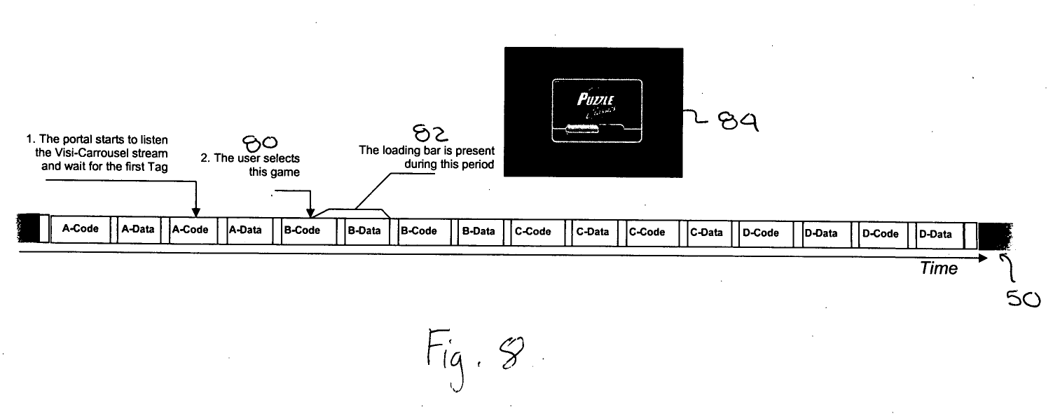

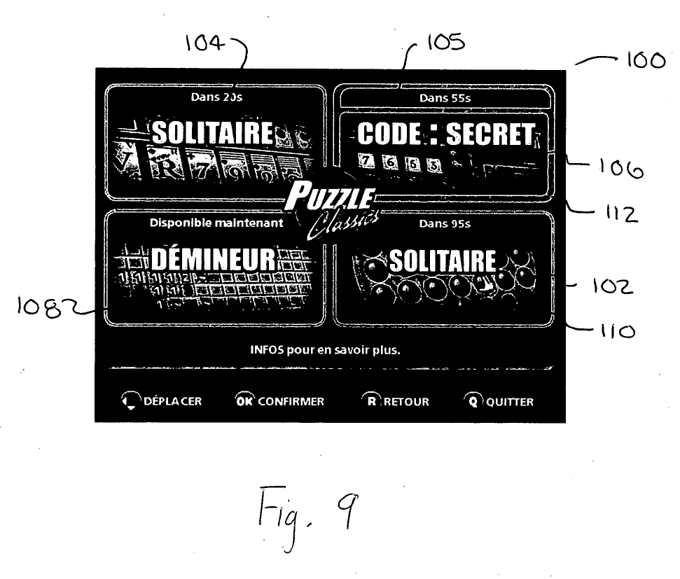

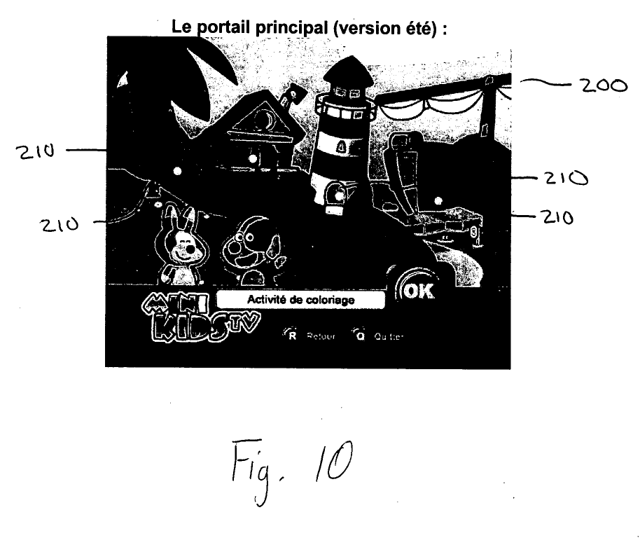

As shown in FIG. 6, each application may comprise a code module and a data module. For example, Game A 34 may comprise a code module (Game A-Code 34A) and a data module (Game A-Data 34B). The code module generally contains source code for the associated application (e.g., game). The data module generally contains date such as, but not limited to, graphics, MPEG pictures, audio, text, pixmaps, bitmaps, or the like. In preferred embodiments, the code module is less than 100 Kbs/s and a data module is less than 80 Kb/s. However, the size of the respective code and data modules is generally controlled by the available memory in the STB. In further preferred embodiments, suitable limits are set for the maximum size of code and data modules, depending upon the expected memory capabilities of the STB (or STBs) included in the system.

In the example embodiment shown in FIG. 5, the EEG tags 64 are disposed within the carouselling data stream, at locations between at least some (and preferably between each) of the different applications 34, 36, 38 and 40. According to a further embodiment of the present invention, the EGG tags 64 may be incorporated into the carouselling broadcast stream in additional locations. By incorporating the EEG tags 64 into many locations in the carousel stream 50 (for example, as many locations as possible or practical) the user would be able to determine the current location along the carouselling broadcast stream and the availability (and time of availability) of applications in the broadcast stream, based on that location. Otherwise, if the games portal is activated through the STB and accesses the carouselling broadcast stream at a location in the middle of an application, the user may not be able to download the current application and would have to wait a period of time (for example, several seconds) until a EGG tag located at the end of an application is detected by the games portal, as discussed further below.

Thus, in the embodiment in FIG. 6, the EGG tags 64 are disposed between the respective data modules and code modules of each of the applications in the carouselling broadcast stream 50, as well as between each different application in the stream 50. Other embodiments may include EGG tags 64 in some, but not all of those locations. By disposing EGG tags 64 between each application and between the code and data modules of each application, two EGG tags 64 may be associated with each given application. In this manner, the user should be able to access and display of a guide associated with the EGG at almost any location within the broadcast stream with minimal delay. Also, because the bandwidth of the PID 32 is static, the games portal can determine the current location in the broadcast stream 50 relative to applications in the stream and can calculate the time period at which a specific application (e.g. game) in the broadcast stream will be available to the user.

With reference to the example embodiment of an EGG 60 in FIG. 4, the example EGG 60 contains information regarding applications contained in the carouselling broadcast stream 50. In further embodiments of an EGG 60, the type of information about applications in the steam 50 and the manner in which the information is formatted and displayed in the EGG 60 may differ from the example shown in FIG. 4. The representative and non-limiting example of an EGG 60 in FIG. 4 includes a table having multiple columns and multiple rows. The first row of the table is titled “CASINO,” indicating that the broadcast stream includes casino game applications. Within the first row, the following applications are identified: Horse, Prohib. Roulette and Black Jack. The table also shows column headings that indicate the availability time of each of the applications in the first row. Thus, in the illustrated embodiment of FIG. 4, the application titled “Horse” is identified in the first column titled “NOW,” indicating the application “Horse” is currently available to the user. Similarly, the application titled “Prohib.” is identified in the second column titled “In 5 s,” indicating that the application “Prohib.” will be available to the user in five seconds. Also similarly, the application titled “Roulette” is identified in the third column titled “In 29 s,” indicating that the application “Roulette” will be available to the user in 29 seconds. The application titled “Black Jack” is identified in the fourth column titled “In 59 s,” indicating that the application “Black Jack” will be available to the user in 59 seconds.

Using the EGG tags 64, the games portal can determine the current location in the broadcast stream and the distance (measured in time) to each of the applications in the stream. When the current location in the broadcast stream reaches the EGG tag 64 between the data module for Game A 34B and code module for Game B 36A, the available application shown in the “Now” column of the EGG 60 will change to the next application in the stream. However, in embodiments (as described with respect to FIG. 6) where two EGG tags correspond to a given application, the available game will not switch to the next application until the games portal detects the EGG flag between the two applications.

By displaying the EGG 60 on the user's STB display, the user may select an application listed on the EGG, for example, through a user interface associated with the games portal, as described in further detail below. Upon selecting an application, the STB processor is configured to retrieve the selected application file (e.g., code and data files associated with the selected application ) from the broadcast stream and store the file(s) in a portion of the STB's electronic memory (such as a temporary buffer memory). In further embodiments, the games portal is configured to retrieve and store each application file (e.g., code and data files for each application) as the application occurs on the broadcast stream, so that the current application will always be stored in the STB's memory at any given time following start up. In such further embodiments, if the user did not select the stored current application, the games portal may save the next currently available application in the broadcast stream over (e.g., write over) the previously saved application, when the broadcast stream proceeds to the next application and the next application becomes the currently available application.

In accordance with a further embodiment of the present invention described in connection with FIG. 7, some (or all) of the applications in the broadcast stream are repeated, such that at least two version of the same application is provided in sequence along the carouselling broadcast stream 50. For example the stream 50 in FIG. 7, the sequence of applications includes repeats of each game application, as follows: Game A 34, Game A 34, Game B 36, Game B 36, Game C 38, Game C 38, ect.

By employing two version of same application in sequence within the broadcast stream, if STB experiences an error in reading one of the application versions (either the code module or the data module), the user will not need wait for the entire carouselling stream to complete and then repeat in order to re-load the erred data. Instead, by employing two versions of each application in sequence in the carousel stream, the games portal can reload the error-laden module, using the second version of that module in the stream. For example, as shown in FIG. 7, if the STB experiences an error reading the date module 34B from the first version of Game A, it can reload that information with the data module 34 D from the second version of Game A. Utilizing this method, read errors can be reduced to 1%, as compared to a 10% error rate when using a single version of the applications in the broadcast stream.

An example of an operation of a games portal with respect to the broadcast stream 50 is also represented in FIG. 7. With reference to step 1 in FIG. 7, the user initially activates the games portal and the games portal begins to read the carouselling broadcast stream at its current location (time) within the stream. When the first EEG tag 64 in the stream is detected, the games portal may determine the current location in the steam and may be capable of displaying an EGG 60, at the user's request. In the illustrated example, the games portal starts to read the PID 50 in the middle of the Game A.

At step 2, the games portal detects the first EGG tag 64 (i.e., the EGG tag for the data module A-Data 34D of the second version of Game A). The games portal is configured to determine (based data in the EGG tag 64) that the first available application is Game B. Thus, at step 2, if the user requests the EGG 60 display, the EGG (see FIG. 4) will indicate that Game B is currently available to the user by listing Game B under the column titled “NOW.”

At Step 3, the full B-Code 36 of the first version of Game B 36 is stored in the games portal's buffer. At step 4, the games portal attempts to read the data module B-Data 36B of the first version of Game B, but experiences a signal error. Accordingly, the games portal is configured to detect and respond to an error in reading the data module for the first version of Game B and waits for the data module for the second version of Game B to appear in the broadcast stream. At step 5, the games portal reads and stores the data module B-Data 36 for the second version of Game B. Thus, after step 5, Game B is fully loaded into the games portal's buffer.

If the user has not selected the application for Game B, then at step 6, the games portal begins to overwrite the modules of Game B with the code module C-Code 38A of the first version of Game C. At this step, the EGG will indicate that Game C is currently available.

At step 7, Game C if fully loaded into the games portal's buffer. At Step 8, the user selects Game C before the end of its second version, so the code and data modules are then stored into the games portal's memory and the user can now play Game C.

With reference to the diagram of FIG. 8, there may be instances where the user selects an application that is indicated as available (see 80), however, the user cannot immediately access the application because the code and data modules for the application have not be fully loaded into the games portal's memory (see 82). In those instances, the games portal may be configured to cause the STB's display to show a loading bar 84, while the selected application is being loaded. However, when the application is fully (or sufficiently) loaded, the loading bar 84 will disappear and the selected application will begin.

The maximum loading time for a given application may be calculated:
tₘₐₓ=2×(data size+code size)/bandwidth

Since the data size, code size and the bandwidth are static, the maximum loading time may be calculated so that games portal can calculate the current location in the carouselling broadcast stream relative to the location at which the selected application is fully (or sufficiently) loaded. In this manner, the games portal may cause the loading bar to disappear from the display at the instant Game B (see FIG. 8) is sufficiently loaded into the STB's memory. In this manner, the STB's display screen may show a loading bar until the selected application (B game) is in memory.

As described above, the user may request the display of an EGG on the user's game portal. Such a request may be entered by a user on the user's games portal, through, for example, a designated button, knob, joy-stick other manual operator, mouse or other cursor controller, touch pad or touch-responsive screen, light pen or other optical input device, or the like, associated with the user's STB.

While one example of an EGG 60 is described above with respect to FIG. 4, other embodiments may employ other displays for interfacing with the user. For example, FIG. 8 shows an embodiment of a user interface display 100 in accordance with a further embodiment of the present invention. The interface display in FIG. 8 comprises a plurality of interactive screen sections 102, each comprising images that correspond to a game in the carouselling broadcast stream. The interface 100 also includes a rectangle highlight box 112 that can be toggled by the user (for example, using a mouse or other cursor controller) to select a game image.

In the embodiment of FIG. 8, the carouselling broadcast stream may contain 4, 8, 12 of 16 games (in multiples of 4), and game images and all the games in the broadcast stream may be accessed in between 2 and 95 seconds. A bandwidth of 180 Kb/s will allow a menu of four games to be broadcast.

In the example of FIG. 8, the interactive screen portions 102 comprise games images entitled “SOLITAIRE” 104, “CODE: SECRET” 106, “DEMINEUR” 108, and “SOLITAIRE” 110. Located top of the games images are status bars 105 that provide the user information regarding a particular games availability. For example, DEMINEUR 108 is presently available to the user and SOLITAIRE 104 will be available to the user in 20 seconds. CODE: SECRET 106 will be available in 55 seconds, and SOLITAIRE 102 will be available in 95 seconds. In that regard, the game images of the available games are outlined in a first color trim, while images of the unavailable games are outlined in a second color trim (different from the first color).

For example, if the user selects CODE: SECRET 106 but the game is not yet available to the user. The rectangle box 112 will blink until that game is available. As soon as the game is available on the interface 100, the system's loading bar will appear until the game is fully loaded into the STB's memory.

Other user interface displays may be designed for particular purposes or for particular groups of users. For example, FIG. 10 depicts a second exemplar interface 200 which is designed for children. The interface of FIG. 10 comprises a plurality of doors 210 (four doors are shown in FIG. 10—one under the of the tree, one to the dog house, one to the lighthouse, and one to the boat). However, only one door can be open at a time. The open door corresponds to the application (e.g., game) currently available to the user.

When a door 210 is opened, a character 220 (e.g. a pink dog) appears. The character may represent a character in application (e.g., game) associated with the open door. The user may select the application by, for example, selecting the character (dog) with a mouse or other cursor controller or by operating a designated button, knob or other manual operator. If the user does not select the character (e.g. pink dog) within a pre-defined time period (e.g., 20 seconds), the character will be displayed as traveling back into the open door (e.g., doghouse), and the door will close. Next, another door will open corresponding to the next available application (e.g. the door of the boat) and a new character will appear to propose that application. Other embodiments may employ other suitable user interface displays.

Embodiments of the present invention are compatible with middleware and broadcast systems using broadcast modules, files and packets. For example, compatible middleware systems may include OpenTV, Media Highway, MPH & Occap, BlueStreak flash, Microsoft foundation, Liberate, or the like. Compatible broadcast systems may include DVB (digital video broadcast), DSS, or the like. Embodiments of the present invention may be adapted for use with any streaming broadcasts system.

While embodiments described above employ a single broadcast channel for communicating a plurality of applications to the user, other embodiments may employ multiple channels, where each channel includes a plurality of applications and wherein the STB operates on the multiple channels in a manner similar to the manner describe above with respect to a single channel. In the multiple channel embodiment, a plurality of different applications may be communicated on each of the multiple channels, to thereby increase the number of applications (or the amount of data) that can accessed by the user, as compared to the multiple channel architecture of FIG. 2 where a single application is communicated on any given channel.

The foregoing description of the preferred embodiment of the invention has been presented for the purposes of illustration and description. It is not intended to be exhaustive or to limit the invention to the precise form disclosed. Many modifications and variations are possible in light of the above teaching.

What is claimed is:

1. A system for receiving a broadcast signal, the system comprising:
a broadcast receiving device having a processor and a receiver for receiving a broadcast stream comprising a plurality of selectable interactive television (ITV) applications on a single channel;
a user interface for allowing a user to select one of the plurality of applications on the single channel.

2. A system as recited in claim 1, wherein the broadcast receiving device further comprises an electronic display and wherein the broadcast receiving device processor is configured to show a guide on the electronic display, wherein the guide includes information identifying the plurality of applications in the broadcast stream.

3. A system as recited in claim 2, wherein, the guide further includes information identifying the time of availability of each of the plural applications in the broadcast stream.

4. A system as recited in claim 2, wherein, the broadcast stream includes a plurality of tags containing information associated with the guide and wherein an ITV application is configured to respond to information in tags to generate the electronic display of the guide.

5. A system as recited in claim 4, wherein the tags are disposed between each application in the broadcast stream.

6. A system as recited in claim 4, wherein each application in the broadcast stream comprises a code module and a data module and wherein the tags are disposed between at least one code module and data module of an application in the broadcast stream.

7. A system as recited in claim 4, wherein each application in the broadcast stream comprises a code module and a data module and wherein the tags are disposed between each code module and data module of each of the plural applications in the broadcast stream.

8. A broadcast signal communication system comprising:
a transmission system for transmitting a broadcast signal comprising a plurality of selectable applications and a plurality of tags on a single channel, the tags being disposed between applications in the broadcast signal;
wherein the tags contain information associated with a displayable information guide having information identifying the applications in the broadcast signal.

9. A system as recited in claim 8, wherein the tags are disposed between each application in the broadcast signal.

10. A system as recited in claim 8, wherein each application in the broadcast signal comprises a code module and a data module and wherein the tags are disposed between at least one code module and data module of an application in the broadcast signal.

11. A system as recited in claim 8, wherein each application in the broadcast signal comprises a code module and a data module and wherein the tags are disposed between each code module and data module of each of the plural applications in the broadcast signal.

12. A broadcast signal communication system comprising:
a transmission system for transmitting a broadcast stream comprising a plurality of selectable applications on a single channel;
at least one broadcast signal receiving device having a processor and a receiver for receiving the broadcast stream comprising a plurality of selectable applications on the single channel;
a user interface for allowing a user to select one of the plurality of applications on the single channel.

13. A system as recited in claim 12, wherein the broadcast signal receiving device further comprises an electronic display and wherein an ITV application (ie games portal) is configured to show a guide on the electronic display, wherein the guide includes information identifying the plurality of applications in the broadcast stream.

14. A system as recited in claim 13, wherein the guide further includes information identifying the time of availability of each of the plural applications in the broadcast stream.

15. A system as recited in claim 13, wherein, the broadcast stream includes a plurality of tags containing information associated with the guide and wherein the an ITV application (ie game portal) is configured to respond to information in tags to generate the electronic display of the guide.

16. A system as recited in claim 15, wherein the tags are disposed between each application in the broadcast stream.

17. A system as recited in claim 15, wherein each application in the broadcast stream comprises a code module and a data module and wherein the tags are disposed between at least one code module and data module of an application in the broadcast stream.

18. A system as recited in claim 15, wherein each application in the broadcast stream comprises a code module and a data module and wherein the tags are disposed between each code module and data module of each of the plural applications in the broadcast stream.
